(19) United States
(12) Patent Application Publication
(10) Pub. No.: US 2008/0309829 A1
(43) Pub. Date: Dec. 18, 2008

(54) FREQUENCY SELECTIVE RADIO SENSOR AND A METHOD THEREOF

(75) Inventors: GENE TURKENICH, Hillsdale, NJ (US); Vasanth Gaddam, Tarrytown, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/138,736

(22) Filed: Jun. 13, 2008

Related U.S. Application Data
(60) Provisional application No. 60/943,921, filed on Jun. 14, 2007.

(51) Int. Cl. H04N 5/50

(52) U.S. Cl. 348/731; 348/E05.097

(57) ABSTRACT

An efficient radio sensor and a method thereof. The radio sensor includes a first frequency tracking block (FTB) (110-i) for tracking an input narrowband signal within a predefined frequency range, wherein the first FTB is preset to a first initial frequency; a second FTB (110-j) for tracking the input narrowband signal within a predefined frequency range, wherein the second FTB is preset to a second initial frequency; a subtractor (130) for subtracting an output value of the first FTB (110-i) from an output value of the second FTB (110-j); and a comparator (140) for applying a convergence test on an output of the subtractor (130) to determine if the input narrowband signal is present.

This application claims the benefit of U.S. Provisional Application No. 60/943,921 filed on Jun. 14, 2007, the contents of which are herein incorporated by reference.

The present invention generally relates to systems for detecting low power radio signals.

In many wireless systems there is a need for identifying the presence of a signal in a given communication channel. As an example, a detection of radio signals broadcast by incumbent (or licensed) transmitters is required in a wireless system that employs unlicensed cognitive radios operating in television (TV) channels. Typically, in such a wireless system if a received incumbent signal exceeds a certain power threshold, the TV channel is deemed to be occupied; otherwise, the TV channel is deemed to be unoccupied and hence available for unlicensed wireless use.

The identification of a signal presence is typically performed by radio sensors that are capable of detecting or sensing a low power signal. Radio sensors discussed in the related art correlate a received signal with prior known embedded patterns and characteristics, where the detection criteria are based upon correlated output energy levels that exceed a preset threshold. For example, a typical process executed by a conventional radio sensor includes sampling an input signal, correlating a known pattern with the fields of the sampled signal to provide peak samples, and comparing peak samples with a threshold to determine a presence of a signal in the communication channel. A known pattern may be, for example, an advanced television systems committee (ATSC) Field Sync data, a spectral signature, and the like.

The disadvantage of conventional radio sensors is that in a low energy signal to noise ratio (SNR) transmission channel environment, the detection results are often unreliable and result in false detections and/or false alarms.

It would be therefore advantageous to provide an efficient radio sensor for detecting low power radio signals.

Certain embodiments of the invention include a radio sensor. The radio sensor comprises a first frequency tracking block (FTB) for tracking an input narrowband signal within a predefined frequency range, wherein the first FTB is preset to a first initial frequency; a second FTB for tracking the input narrowband signal within a predefined frequency range, wherein the second FTB is preset to a second initial frequency; a subtractor for subtracting an output value of the first FTB from an output value of the second FTB; and a comparator for applying a convergence test on an output of the subtractor to determine if the input narrowband signal is present.

Certain embodiments of the invention include a radio sensor. The radio sensor comprises a frequency tracking block (FTB) for tracking an input narrowband signal within a predefined frequency range, wherein the FTB is preset alternately in time to at least a first initial frequency and a second initial frequency; a delay line for delaying an output signal of the FTB by a dwell time determined by a predefined detection time period; a subtractor for subtracting a first output value of the FTB from a second output value of the FTB, wherein the second output is delayed by the dwell time relative to the first output; and a comparator for applying a convergence test on an output of the subtractor to determine if the input narrowband signal is present.

Certain embodiments of the invention include a method for detecting radio signals. The method comprises presetting at least two frequency tracking block (FTBs) to their initial frequencies; by each of the FTBs, tracking an input narrowband signal; determining if outputs of at least two FTBs tracking the same input narrowband signal are converged; generating a signal present message if the at least two FTBs are converged; and generating a signal absent message if the at least two FTBs are not converged.

Certain embodiments of the invention include a computer-readable medium having stored thereon computer executable code for detecting radio signals. The computer executable code causes a computer to perform the process of presetting at least two frequency tracking block (FTBs) to their initial frequencies; by each of the FTBs, tracking an input narrowband signal; determining if outputs of at least two FTBs tracking the same input narrowband signal are converged; generating a signal present message if the at least two FTBs are converged; and generating a signal absent message if the at least two FTBs are not converged.

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

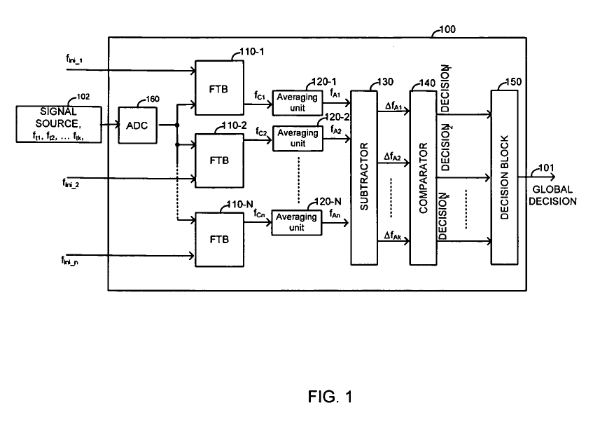

FIG. 1 is a block diagram of a radio sensor realized in accordance with an embodiment of the invention.

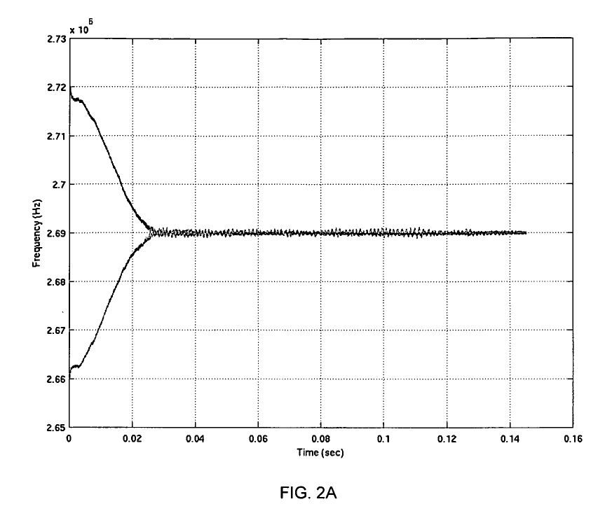

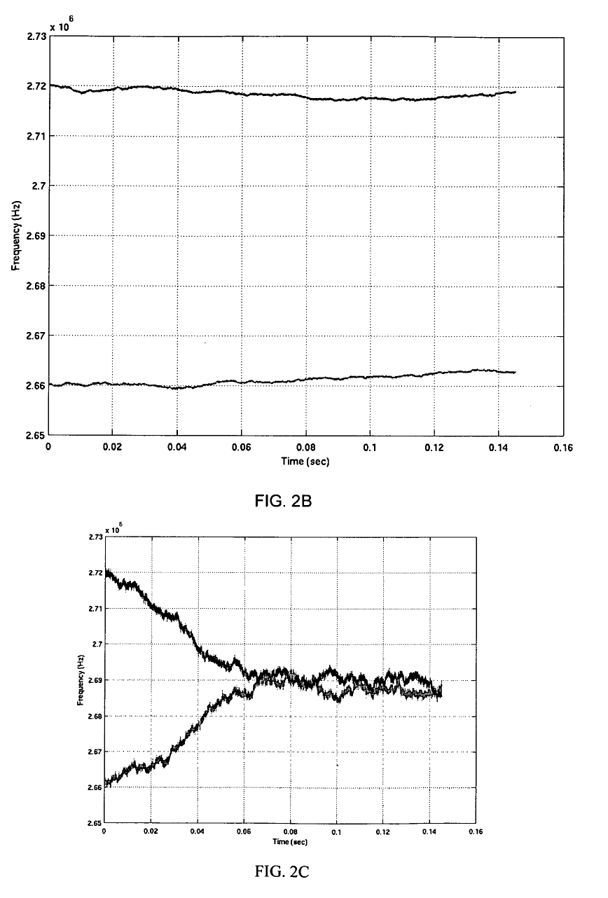

FIGS. 2A, 2B and 2C are exemplary graphs showing the tracking of a narrowband signal by a pair of FTBs.

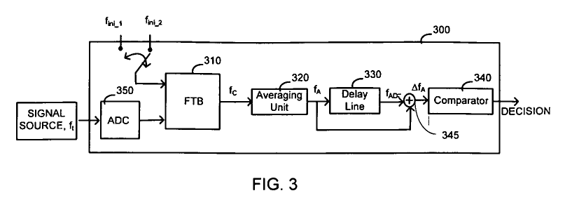

FIG. 3 is a block diagram of a radio sensor constructed in accordance with another embodiment of the invention.

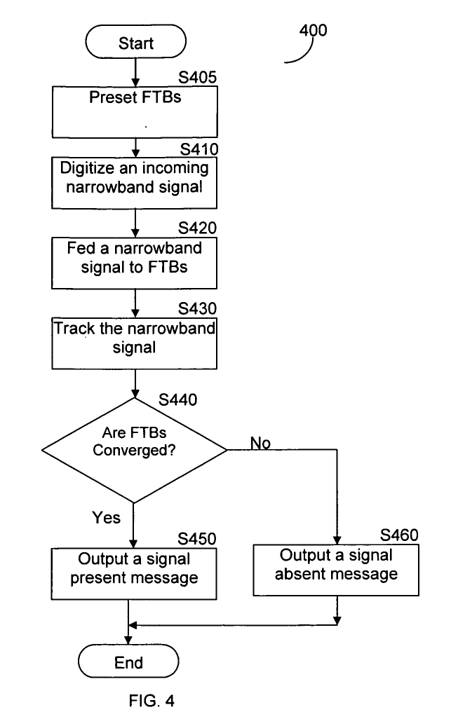

FIG. 4 is a flowchart describing the method for detecting low power signals implemented in accordance with an embodiment of the invention.

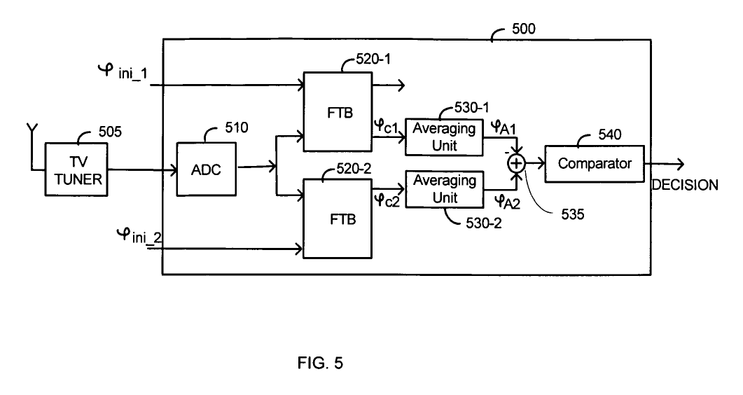

FIG. 5 is a block diagram of a radio sensor constructed to detect ATSC pilots in accordance with an embodiment of the invention.

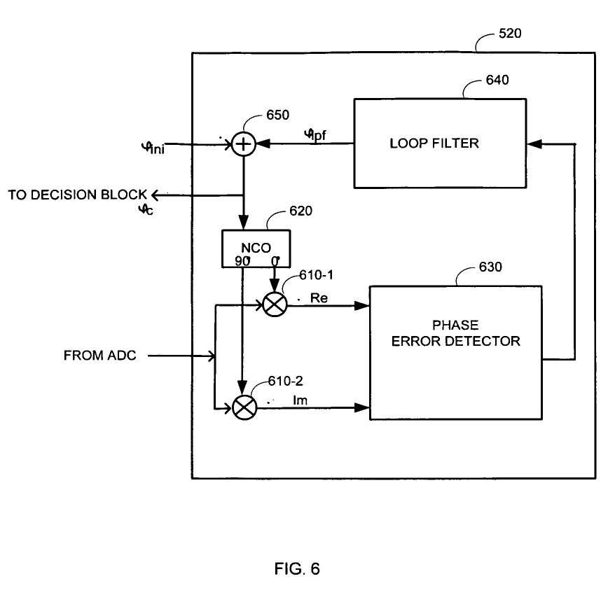

FIG. 6 is a block diagram of an exemplary FTB of a FPLL type.

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In certain embodiments of the invention a frequency selective agile radio sensor adapted to detect the presence and identify the type of radio signals is provided. The radio sensor detects narrowband signals at a priori known frequency position(s) within a channel of a broadcast transmission standard. The detection is achieved using a number of frequency tracking blocks (FTBs) that are offset from the nominal values of the narrowband signal frequencies contained within the input signal. The detection criterion is based upon convergence within a predefined differential frequency threshold of the outputs of two or more FTBs tracking the same input narrowband signal frequency. That is, the radio sensor is based on a more robust differential frequency threshold criterion and not on the amplitude and/or energy threshold detection, thereby ensuring the reliable detection of very low energy (e.g., −120 dbm in a 6 MHz TV band) radio signals.

FIG. 1 shows an exemplary and non-limiting block diagram of a radio sensor 100 realized in accordance with an embodiment of the invention. The radio sensor 100 includes a plurality of FTBs 110-1 through 110-N, where N is a positive integer greater than 1, coupled to a number of N averaging units 120-1 through 120-N, a subtractor 130, a comparator 140, a decision block 150, and an analog-to-digital convertor (ADC) 160. The FTBs 110-1 through 110-N may be constructed as phase lock loop (PLL) devices or devices of a similar functionality.

The radio sensor 100 outputs a Boolean signal 101 indicating the presence or absence of a source signal 102. The source signal 102 contains narrowband signals at nominal frequencies fₜ₁, fₜ₂, . . . , fₜₖ. A narrowband signal may be either one of a tone, a pilot, a carrier, a harmonic, and so on. An actual received frequency, f₁, of an input narrowband signal could deviate from the nominal expected value due to various reasons, such as communication channel propagation phenomena, a receiver's architecture, and so on.

The source signal 102 is digitized by the ADC 160 and fed into at least two FTBs 110-1 through 110-N. An FTB 110-i, where i is a positive integer, is capable of tracking an input narrowband signal, fₜᵢ, within a predefined frequency range. If the signal, fₜᵢ, is outside the predefined tracking frequency range of the FTB 110-i or if the energy level of that signal is a lower than a detection level of FTB-110-i or if the signal does not exist, the FTB 110-i output, f_{ci}, maintains a value equal to an initial preset constant, fᵢₙᵢ_{_{—}}ᵢ. Otherwise, the output, f_{ci} is actively tracking the input narrowband signal, i.e. the output, f_{ci}, moves in a direction corresponding to the narrowband signal frequency, fₜᵢ. When the preset value, fᵢₙᵢ_{_{—}}ᵢ, precisely matches the frequency of the input narrowband signal, fₜᵢ, the output, f_{ci}, of the FTB 110-i maintains its preset value, fᵢₙᵢ_{_{—}}ᵢ. The preset constant, fᵢₙᵢ, defines the initial output value, f_{ci} immediately after, for example, a reset or a power up of a FTB 110-i.

In accordance with certain principles of the invention, at least two FTBs, e.g., FTB-110-1 and FTB-110-2 are needed to track a single narrowband signal at a nominal frequency, fₜᵢ. FTBs 110-1 and 110-2, tracking the same input narrowband signal, fₜᵢ, are initially preset with individual frequencies, fᵢₙᵢ, which are set apart from each other and from a nominal frequency of the narrowband signal, fₜᵢ.

A system with two or more FTBs resolves an inherent problem of a single FTB detection system that cannot definitively correlate the output with the input signal in some situations. Specifically, the ambiguity in a single FTB system appears when the output value, f_{ci} continuously maintains the preset frequency, fᵢₙᵢ, after the reset is removed. In a single FTB system this could be interpreted in two mutually exclusive ways: a) the received input frequency, fₜᵢ, is present and precisely matches the frequency, fᵢₙᵢ or b) the received input frequency, fₜᵢ, is not present at all. This ambiguity is eliminated if at least two FTBs are used to detect an incoming narrowband signal and are properly setup. As an example, if an input narrowband signal, fₜ₁, is being tracked by the FTB 110-1 and FTB 110-2, their output frequencies, f_{ci-1} and f_{ci-}, can be initialized to the following values:

f_{ci-1}=fᵢₙᵢ_{_{—}}₁=α(fₜ₁+δ₁); and [1]

f_{ci-2}=fᵢₙᵢ_{_{—}}₂=α(fₜ₁-δ₁) [2]

where: +/−δ₁ is a possible deviation of the incoming frequency fₜ₁ from its nominal value and α is a proportionality sign.

A convergence of the outputs, f_{c1} and f_{c2}, which are initially preset apart, of two FTBs 110-1 and 110-2 within a predefined frequency threshold value and within a predefined detection time period indicates a presence of an input narrowband signal, at least until the moment of convergence. A lack of convergence is considered as an absence of the narrowband signal. This is clearly demonstrated in FIGS. 2A and 2B.

As illustrated in FIG. 2A, a preset frequency, fᵢₙᵢ_{_{—}}₁, of FTB 110-1 and a preset frequency fᵢₙᵢ_{_{—}}₂ of FTB 110-2 are respectively set to 2.72 MHz and 2.66 MHz, where both a nominal frequency and an actual input frequency of an expected narrowband signal are at 2.69 MHz. In this example, the outputs of the FTB 110-1 and 110-2 converged between themselves within a predefined frequency threshold (e.g., 0.02 MHz), and within a predefined detection time period (e.g., 40 msec), thereby indicating a detection of the narrowband signal. A lack of convergence is shown in FIG. 2B where the two FTBs cannot track the narrowband signal at a frequency of 2.69 MHz under the same threshold conditions.

It should be noted that if the fₜ ceases after a convergence was reached, the FTBs 110-i may stay converged, i.e., appearing that the outputs of the FTBs 110-i through 110-j converged. In order to avoid such situations, the FTBs 110-i through 110-j are periodically reset to their initial frequencies. It should be further noted that the individual narrowband signals comprising an input source spectral signature should be separated by at least 26 to avoid false detection between the groups of the FTBs 110-i tracking adjacent input narrowband signals.

The output of each of FTBs 110-i through 110-j (where j is a positive integer) is averaged by its respective averaging unit 120-i through 120-j. Average values, fA, are fed into the subtractor 130. The subtractor 130 calculates the differences between all averaged outputs, f_{c}, of averaging units 120-i through 120-j coupled to FTBs 110-i through 110-j which track a common narrowband signal, fₜ₁. As an example, if FTBs 110-1 and 110-2 track the narrowband signal fₜ₁, then only averaged values output by averaging units 120-1 and 120-2 are subtracted by the subtractor 130 to define the detection status of fₜ₁. In cases, when more than two FTBs are used for tracking a single narrowband signal, the subtractor 130 calculates the differences between predefined, possibly partly overlapping, pairs of FTBs, where the FTBs within a given pair have their preset values, fᵢₙᵢ, defined according to equations [1] and [2] above.

The calculated differences, ΔfA, between the outputs of averaging units 120-i through 120-j (coupled to FTBs 110-i through 110-j that track a common narrowband signal) are fed into the comparator 140, which compares the absolute values of calculated differences with the predefined thresholds. A set of FTBs 110-i through 110-j is considered to be converged when their calculated ΔfA is less than a predefined frequency threshold. Referring to the above example, the output of the comparator 140, Decision_1, may be defined as follows:

Decision_{—}1=thresh1−ΔfA

where ΔfA is the output of the comparator 140 and equals to:

ΔfA=|fA1−fA2|

where fA1 and fA2 are the outputs of the averaging units 120-1 and 120-2 respectively. The “thresh1” parameter is a constant that predefines a frequency convergence threshold and, subsequently, a detection criterion. The Decision_1 is “Hit” if at least two FTBs 110-i through 110-j tracking a common narrowband signal are converged within a predefined frequency threshold (i.e. Decision 1>0); otherwise, the decision is a “Miss”. In cases, when more than two FTBs are used for tracking a single narrowband signal, the subtractor 130 calculates the differences as described above, and more than one ΔfA value will be calculated for the same input narrowband signal to be detected. In this case the decision block 150 verifies convergence of all ΔfA values, or of a predefined number of ΔfA values, or predefined ΔfA values that were calculated for the same narrowband signal. Similarly, a positive identification of broadcast transmission standards is possible if all or predefined narrowband signals or a predefined number of the narrowband signals within a standard spectral signature were detected. In this case the decision outputs of the comparator 140 are fed into the decision block 150 that verifies that predefined narrowband signals or a predefined number of the narrowband signals of the input signal spectral signature are detected. If they are, a Boolean signal at the output 101 indicates a positive detection. The radio sensor 100 is particularly useful to detect low power narrowband signals at very low SNR levels. As illustrated in FIG. 2C a detection of a noisy signal (a simulation result at SNR=−15 db) is achieved using the previously mentioned exemplary threshold values for the frequency (0.02 MHz) and detection time period (40 msec).

In accordance with one embodiment of the invention, the detection of a narrowband signal can be performed using a single FTB 310 which is alternately initialized with two preset frequencies. A non-limiting block diagram of a radio sensor 300 implementing such technique is shown in FIG. 3. The radio sensor 300 includes a FTB 310, an averaging unit 320, a delay line 330, a comparator 340, subtractor 345, and an analog-to-digital (ADC) 350. A source signal including a narrowband signal at a frequency, ft, is digitized and fed into the FTB 310, which is alternately initialized with one of two preset frequencies fᵢₙᵢ_{_{—}}₁ and fᵢₙᵢ_{_{—}}₂. The values of these initializing preset frequencies fᵢₙᵢ_{_{—}}₁ and fᵢₙᵢ_{_{—}}₂ are set apart from each other and from a nominal value of the narrowband signal frequency, fₜᵢ. The FTB 310 is periodically reset and switched between two preset input values at a rate (dwell time) which is not less than a predefined detection time period.

The FTB 310 preset input multiplexes in time between fᵢₙᵢ_{_{—}}₁ and fᵢₙᵢ_{_{—}}₂ in order to lock on the signal ft, causing the preset output values to alternate between the values of fᵢₙᵢ_{_{—}}₁ and the fᵢₙᵢ_{_{—}}₂. The delay of the delay line 330 is chosen to be equal to the “dwell time”. As a result, the subtractor 345 always operates on the direct and delayed averaged data streams, fA. These two streams are generated by the FTB 310 operating from two different preset frequencies, fᵢₙᵢ_{_{—}}₁ and fᵢₙᵢ_{_{—}}₂. Therefore, the subtractor 345 computes the difference ΔfA between the values of the output f_{c} corresponding to the two different switching states. If ΔfA is smaller than a predefined frequency convergence threshold then the narrowband signal fₜ is considered to be detected. The comparator 340 applies the same logic as the comparator 140.

The exemplary radio sensor 300 as discussed herein detects a single narrowband signal at a nominal frequency ft. However, the inventive sensor 300 can be adapted for detecting a source signal containing multiple narrowband signals.

FIG. 4 shows a non-limiting and exemplary flowchart 400 describing the method for detecting low power signals in accordance with an embodiment of the invention. While operation of the method herein is discussed for detection of one narrowband signal, this is performed for exemplary purposes only. Specifically, the discussed method is applicable to sensors capable of detecting multiple narrowband signals contained in a received source signal.

At S405 FTBs are set to their initial preset frequencies. At S410, an input source signal including at least one narrowband signal is converted to a digital signal using an analog-to-digital converter. At S420, the narrowband signal is fed into at least two FTBs, where each FTB is set with its own initial preset frequency. Alternatively, the narrowband signal is input to a single FTB, which is alternately initialized with at least two different preset frequencies. At S430, each FTB tries to track the narrowband signal starting from the preset frequency, within a predefined frequency range. If at least two FTBs converge within the predefined frequency and detection time period thresholds, the narrowband signal is considered detected; otherwise, the narrowband signal is considered absent. At S440, it is determined if the at least two FTBs converged on the narrowband signal. The determination is made by checking if the absolute value of the difference of, for example, averaged values of the FTB outputs is smaller than a predefined frequency threshold. If S440 results into a “Yes” answer, then, at S450, a “signal present” message is output; otherwise, at S460, a “signal absent” message is reported. It should be noted that the check if two FTBs converged sufficiently is performed during a predefined detection time period. If the convergence is not achieved during that detection time period, a “signal absent” message is reported. It should be further noted that if only one FTB is used, the convergence decision is based on the difference between the output values of the FTB when preset with two or more different preset frequencies.

The radio sensors and method described herein can be utilized in various radio transmission applications including, but not limited to, sensing elements of cognitive radios that detect digital TV transmissions (such as, Vestigial SideBand (VSB) ATSC transmission) and so on. An exemplary implementation of a radio sensor 500 for detecting a pilot in an ATSC 8VSB transmission is shown in FIG. 5. An ATSC broadcast signal is fed from an antenna into a dual conversion tuner 505. The pilot carrier at 2.69 MHz is present at the output of the dual conversion tuner 505. This output signal is digitized by an ADC 510, and then fed into two FTBs 520-1 and 520-2. In accordance with a preferred embodiment the FTBs 520-1 and 520-2 are of the frequency and phase locked loop (FPLL) type. The FTBs 520-1 and 520-2 are preset with initial angular increment values φᵢₙᵢ_{_{—}}₁ and φᵢₙᵢ_{_{—}}₂ respectively.

An exemplary block diagram of an FTB 520 is shown in FIG. 6. The input pilot signal is converted to a complex form by multiplying the signal, using multipliers 610-1 and 610-2, by two sine waves shifted by 90 degrees. The sine waves are generated by a numerically controlled oscillator (NCO) 620.

A NCO 620 is a sine/cosine lookup table that is fed by a modulo 2π accumulator. The NCO 620 input receives a phase increment, which is added to the accumulator on each system clock. In a preferred embodiment the system clock is at a constant frequency of the pilot multiplied by eight (8), i.e., 2.69 MHz×8=21.52 MHz. When the FTB 520 is locked on the incoming pilot, the NCO 620 advances by 2π/8(or 45 degrees) on each clock.

The Real (Re) and Imaginary (Im) parts of the complex signal are fed into a phase error detector 630, which outputs a phase error value, both a sign and a magnitude. A loop filter 640 computes a frequency error which is the difference between the initial preset frequency and the actual pilot frequency in the incoming signal. The actual pilot frequency is derived from the phase error value. Using the frequency error the loop filter 640 computes and outputs combined phase/frequency error data, φ_{1pf}, This data is added to the initial phase increment, φ_{c}, by an adder 650, to generate a final phase increment φ_{c}, at the output of the FTB 520, which also defines the NCO output frequencies.

Referring back to FIG. 5, the output of the FTBs 520-1 and 520-2 are averaged by averaging units 530-1 and 530-2, subtracted by a subtractor 535, and input to a comparator 540. As described in detail above, the comparator 540 generates a detection decision based on a convergence test.

The foregoing detailed description has set forth a few of the many forms that the present invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention are implemented in hardware, firmware, software, or combination thereof. Moreover, the hardware maybe a digital circuit, an analog circuit, or combination thereof. Furthermore, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPU”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What we claim is:

1. A radio sensor (100) comprising:
a first frequency tracking block (FTB) (110-i) for tracking an input narrowband signal within a predefined frequency range, wherein the first FTB is preset to a first initial frequency;
a second FTB (110-j) for tracking the input narrowband signal within the predefined frequency range, wherein the second FTB is preset to a second initial frequency;
a subtractor (130) for subtracting an output value of the first FTB (110-i) from an output value of the second FTB (110-j); and
a comparator (140) for applying a convergence test on an output of the subtractor (130) to determine if the input narrowband signal is present.

2. The radio sensor of claim 1, further comprising at least one of:
an analog-to-digital convertor (ADC) (160) for digitizing an analog input narrow band signal;
a first averaging unit (120-i) for averaging the output value of the first FTB (110-i); and
a second averaging unit (120-j) for averaging the output value of the second FTB (110-j).

3. The radio sensor of claim 1, wherein the input narrowband signal is at least one of: a tone, a pilot, a carrier, and a harmonic.

4. The radio sensor of claim 1, wherein the first initial frequency and the second initial frequency are preset apart from each other and from a nominal frequency of the input narrowband signal.

5. The radio sensor of claim 1, wherein the convergence test includes checking if an absolute value of the output of the subtractor (130) reaches a value that is smaller than a predefined frequency threshold within a predefined detection time period.

6. The radio sensor of claim 5, wherein the comparator (140) outputs a signal present message when the convergence test is satisfied; otherwise, the comparator (140) outputs a signal absent message.

7. The radio sensor of claim 1, wherein the input narrowband signal is identified by detecting either a predefined number of narrowband signals within a spectral signature of the input narrowband signal or predefined narrowband signals within a priori known spectral signature of the input narrowband signal.

8. A radio sensor, comprising:
a frequency tracking block (FTB) (310) for tracking an input narrowband signal within a predefined frequency range, wherein the FTB (310) is preset alternately in time to a first initial frequency and a second initial frequency;
a delay line (330) for delaying an output signal of the FTB (310) by a dwell time set according to a predefined detection time period;
a subtractor (345) for subtracting a first output value of the FTB (310) from a second output value of the FTB (310), wherein the second output value is delayed by the dwell time relative to the first output value; and
a comparator (340) for applying a convergence test on an output of the subtractor (345) to determine if the input narrowband signal is present.

9. The radio sensor of claim 8, further comprising at least one of:
an analog-to-digital convertor (ADC) 350 for digitizing an analog input narrow band signal; and
an averaging unit (320) for averaging output values of the FTB (330).

10. The radio sensor of claim 8, wherein the input narrowband signal is at least one of: a tone, a pilot, a carrier, and a harmonic.

11. The radio sensor of claim 8, wherein the first initial frequency and second initial frequency are preset apart from each other and from a nominal frequency of the input narrowband signal.

12. The radio sensor of claim 8, wherein the convergence test includes checking if an absolute value of output of the subtractor (345) reaches a value that is smaller than a predefined frequency threshold within a predefined detection time period.

13. The radio sensor of claim 8, wherein the comparator (340) outputs a signal present message when the convergence test is satisfied; otherwise, the comparator (340) outputs a signal absent message.

14. The radio sensor of claim 8, wherein the input narrowband signal is identified by detecting either a predefined number of narrowband signals within a spectral signature of the input narrowband signal or predefined narrowband signals within a priori known spectral signature of the input narrowband signal.

15. A method (400) for detecting radio signals, comprising:
presetting at least two frequency tracking block (FTBs) to their initial frequencies (S405);
tracking an input narrowband signal by each of the FTBs (S430);
determining if outputs of at least two of the FTBs tracking the input narrowband signal converge (S440); and
generating a signal present message if the at least two FTBs converge (S450).

16. The method of claim 15, wherein the initial frequencies are preset apart from each other and from a nominal frequency of the input narrowband signal.

17. The method of claim 15, wherein determining if the outputs of the at least two FTBs tracking the input narrowband signal converge further comprises:
computing a difference value between the outputs of the at least two FTBs; and
checking if an absolute value of the difference value is smaller than a predefined frequency threshold, wherein the determination is performed within a predefined detection time period.

18. The method of claim 15, further comprises:
identifying the input narrowband signal by detecting either a predefined number of narrowband signals within a spectral signature of the input narrowband signal or predefined narrowband signals within a priori known spectral signature of the input narrowband signal; and
generating a signal absent message if the at least two FTBs do not converge (S460).

19. The method of claim 15, wherein the at least two FTBs are preset to their initial frequencies either at predefined time intervals or upon an occurrence of a predefined event.

20. A computer-readable medium having stored thereon computer executable code for detecting radio signals, comprising:
presetting at least two frequency tracking block (FTBs) to their initial frequencies (S405);
tracking an input narrowband signal by each of the FTBs (S430);
determining if outputs of at least two FTBs tracking the input narrowband signal converge (S440); and
generating a signal present message if the at least two FTBs converge (S450).
